(19) United States
(12) Patent Application Publication
(10) Pub. No.: US 2007/0042799 A1
(43) Pub. Date: Feb. 22, 2007

(54) Auto adaptive technique to provide adequate coverage and mitigate RF interference

(75) Inventors: John C. Jubin, Richardson, TX (US); Nivi Thadasina, Allen, TX (US); Vijayasimman Rajasimman, Dallas, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/431,395

(22) Filed: May 10, 2006

Related U.S. Application Data
(60) Provisional application No. 60/687,229, filed on Jun. 3, 2005.

(51) Int. Cl. H04B 7/00; H04Q 7/20

(52) U.S. Cl. 455/522

(57) ABSTRACT

A method and system for optimizing the transmit power within a wireless network. The required change in transmit power of a home base station is determined by measured pilot strengths at the home mobile stations and/or at foreign mobiles stations, both from the home base station and a macro base station, and by desired pilot strengths or a desired ratio of pilot strengths. These transmit power adjustments by the home base station minimize the interference to foreign mobile stations served by macro base stations and by other home base stations, while optimizing coverage for home mobile stations served by the home base station.

### CROSS-REFERENCE TO RELATED APPLICATION AND CLAIM OF PRIORITY

The present application is related to U.S. Provisional Patent No. 60/687,229, filed Jun. 3, 2005, entitled “AUTO ADAPTIVE TECHNIQUE TO MITIGATE RF INTERFERENCE”. U.S. Provisional Patent No. 60/687,229 is assigned to the assignee of the present application and is hereby incorporated by reference into the present disclosure as if fully set forth herein. The present application hereby claims priority under 35 U.S.C. §119(e) to U.S. Provisional Patent No. 60/687,229.

### TECHNICAL FIELD OF THE INVENTION

The present application relates generally to CDMA wireless networks, and more specifically, to techniques for mitigating interference and maintaining RF coverage.

### BACKGROUND OF THE INVENTION

Inadequate coverage is a persistent problem in the quality of service of any wireless network. Natural and man-made obstacles frequently create radio frequency (RF) holes in the coverage area of a wireless network. Voice and data call connections are frequently dropped when a wireless terminal, such as a cell phone or a similar mobile station, enters an RF hole. Mobile stations that are already in an RF hole may not be able to reliably establish new connections. Typical areas in which RF holes occur include homes, apartments, underground tunnels and office buildings. RF interference may become especially apparent in future Internet Radio applications.

A “home base station” (HBS) can be used to fill an RF hole in a home, for the home mobile devices, or mobile stations. However, an HBS typically cannot provide service to foreign mobile stations, which are served by macro-network base stations.

Typically, an HBS causes significant RF interference to foreign mobile stations served by a macro base station (BS) on the same code division multiple access (CDMA) channel (i.e., frequency). When a mobile station is served by two macro base stations on the same frequency, it can be in soft handoff with both of them, thereby overcoming the RF interference that each causes to the other's signal. However, a mobile station typically cannot be in soft handoff with an HBS and a macro BS. An HBS must be able to intelligently detect the presence of foreign mobile stations and mitigate its interference with respect to them. Otherwise, HBS interference to foreign mobile stations could be unacceptably high. At the same time, the HBS should not sacrifice coverage to its home mobile stations. In short, the principal challenge of system optimization is achieving sufficient RF coverage without interfering with users in neighboring cells.

Conventional operational procedures and field tests optimize CDMA cell sites using manual procedures. These procedures are often very expensive and significantly add to capital and operational expenditures. Not only are manual operational procedures and field tests expensive, but they are often times very tedious and time consuming, requiring the aid of a number of personnel to complete. Thus, if an operator wishes to quickly expand cellular coverage by, for example, installing new cells, the amount of human resources needed usually prohibits quick expansion of cell coverage.

There is therefore a need for an autonomous system to manage power adjustments by a home base station to minimize the interference to foreign mobile stations served by macro base stations and by other home base stations, while optimizing coverage for home mobile stations.

### SUMMARY OF THE INVENTION

A system is provided, for use in a CDMA wireless network, for allowing a base station to intelligently and autonomously balance RF coverage and interference without depending on field technicians or engineers.

In one embodiment, a system for optimizing transmit power in a wireless communication network is disclosed. The system includes a home base station (HBS) capable of communicating with a first mobile station and a second mobile station within a wireless network. The HBS is also capable of setting an optimized HBS transmit power to provide an adequate pilot strength at the first mobile station from the HBS. The optimized HBS transmit power is determined by a current HBS transmit power, a current pilot strength at the first mobile station, and a ratio between a total overhead transmit power to a pilot channel transmit power.

In another embodiment, a method for configuring a home base station (HBS) for use in a wireless communication network is disclosed. The method includes setting an optimized transmit power of the HBS. The setting the optimized transmit power provides at least one of: (1) an acceptably high pilot strength at a second mobile station from a second base station associated with the second mobile station; (2) an acceptably low pilot strength at the second mobile station from the home base station; (3) a desired ratio of pilot strengths at the second mobile station; and (4) an adequate pilot strength at the first mobile station from the HBS determined by a current HBS transmit power, a current pilot strength at the first mobile station, and a ratio between a total overhead transmit power to a pilot channel transmit power.

In still another embodiment, a computer program embodied on a computer readable medium and capable of being executed by a processor in a wireless communication network is disclosed. The computer program includes computer readable program code for a home base station (HBS) capable of communicating with a first mobile station and a second mobile station within a wireless network. The computer readable program code is also capable of setting an optimized HBS transmit power to provide an adequate pilot strength at the first mobile station from the HBS. The optimized HBS transmit power is determined by a current HBS transmit power, a current pilot strength at the first mobile station, and a ratio between a total overhead transmit power to a pilot channel transmit power.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network providing context for the disclosure;

FIG. 2 illustrates possible coverage versus interference scenarios according to an exemplary embodiment of the disclosure; and

FIG. 3 is a flow diagram illustrating a method according to an exemplary embodiment of the disclosure.

### DETAILED DESCRIPTION OF THE INVENTION

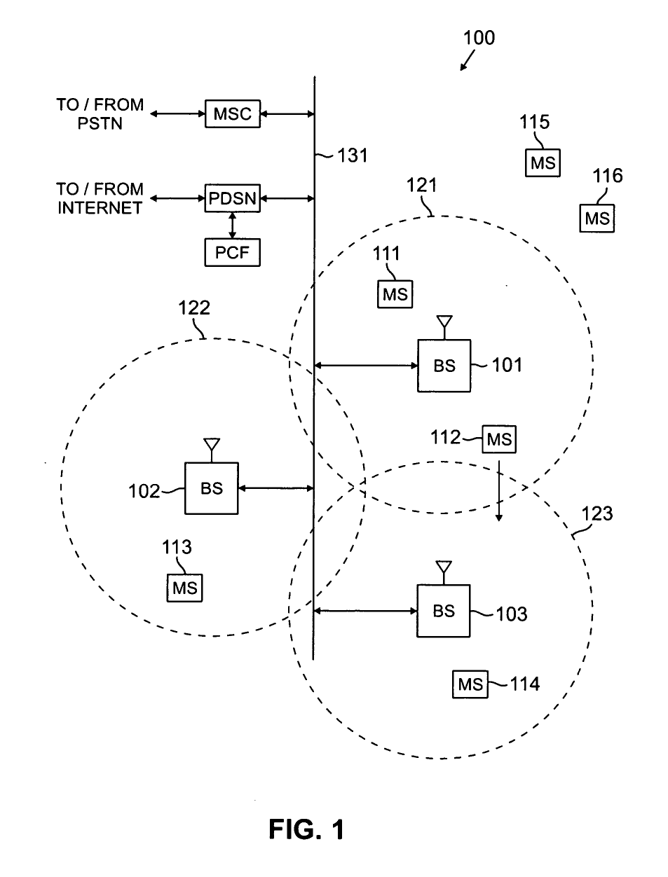

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

FIG. 1 illustrates exemplary wireless network 100, providing a context for the present disclosure. Wireless network 100 comprises a plurality of cells 121-123, each containing one of the base stations, BS 101, BS 102, or BS 103. Base stations 101-103 communicate with a plurality of mobile stations, MS 111-114, over code division multiple access (CDMA) channels. Mobile stations MS 115 and MS 116 primarily communicate with other base stations (not shown). Mobile stations 111-116 may be any suitable wireless devices (e.g., conventional cell phones, PCS handsets, personal digital assistant (PDA) handsets, portable computers, telemetry devices) that are capable of communicating with base stations 101-103 via wireless links. It should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cells 121-123 in which base stations 101-103 are located. The cells are shown approximately circular for the purposes of illustration and explanation only. It should be clearly understood that the cells may have other irregular shapes, depending on the cell configuration selected and variations in the radio environment associated with natural and man-made obstructions.

As is well known in the art, each of cells 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present disclosure is not limited to any particular cell configuration.

A base transceiver subsystem comprises the RF transceivers, antennas, and other electrical equipment located in each cell. For the purpose of simplicity and clarity in explaining the operation of the present disclosure, the base transceiver subsystems in each of cells 121, 122 and 123 are collectively represented by BS 101, BS 102 and BS 103, respectively.

In a CDMA environment, pilot strength (Ec/Io) is the ratio of the received pilot energy (Ec) of the desired base station to the total received energy or the total power spectral density (i.e., noise and signals) (Io) at the current CDMA frequency. The signals in the total power spectral density include those from the desired base station and those from other base stations. Any signals from other base stations are considered interference. A mobile station in the Idle State reports pilot strengths measured from its serving base station and any neighboring base stations to its serving base station in Radio Environment Reports, Registration Messages, Origination Messages, and similar messages.

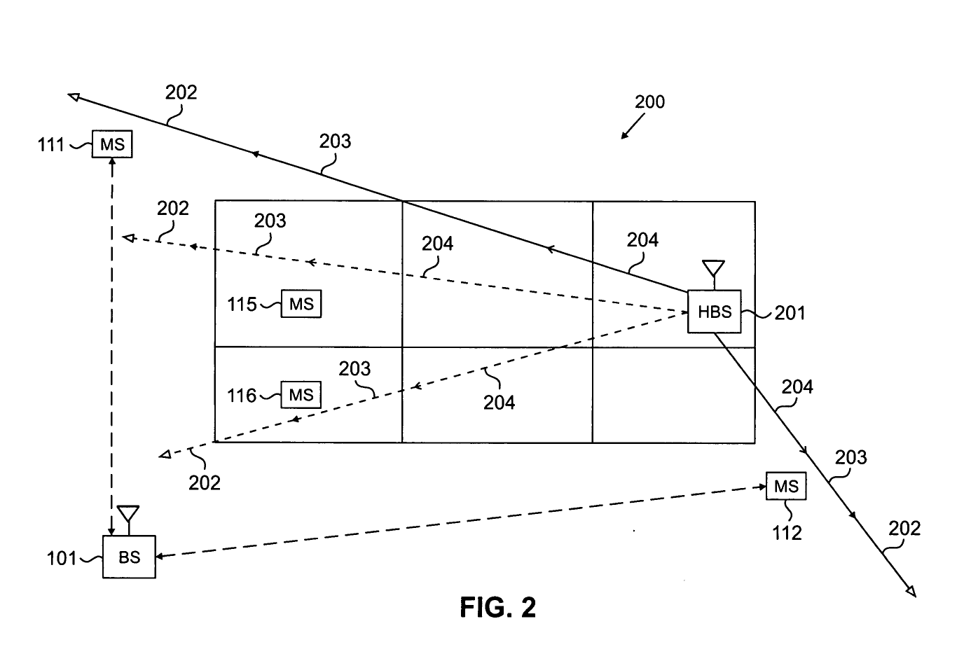

FIG. 2 depicts a wireless communication system 200 according to an exemplary embodiment of the disclosure, including home base station (HBS) 201 and macro base station BS 101. In the example shown, macro BS 101 normally maintains coverage for its mobile stations, MS 111 and MS 112, as shown in FIG. 1. Similarly, HBS 201 normally maintains coverage for its home mobile stations, MS 115 and MS 116. With respect to HBS 201, MS 111 and MS 112 may be referred to as foreign mobile stations. Depending upon the transmit power of HBS 201, several interference scenarios are possible. For the following interference examples, assume that even when HBS 201 is not transmitting, macro BS 101 provides only marginal coverage to MS 112.

In one example, suppose HBS 201 is transmitting at a first power level 202 (e.g., a maximum power). First power level 202 is illustrated in FIG. 2 as a line originating from HBS 201 and culminating in an outline-styled arrow. At first power level 202, HBS 201 provides coverage to both home mobile stations, MS 115 and MS 116, but significantly interferes with foreign mobile stations, MS 111 and MS 112.

As another example, suppose HBS 201 is transmitting at a second power level 203 (e.g., a power level less than maximum power). Second power level 203 is illustrated in FIG. 2 as a line originating from HBS 201 and culminating in a darkened arrow. At second power level 203, HBS 201 maintains coverage to both home MS 115 and MS 116. Foreign MS 111 now experiences an acceptably low level of interference from HBS 201. Foreign MS 112, on the other hand, still experiences too much interference from HBS 201 (i.e., too low a pilot strength or signal-to-interference ratio with respect to macro BS 101), because the coverage provided by BS 101 to MS 112 was already marginal.

In yet another example, suppose that HBS 201 transmits at a third transmit power level 204 (e.g., a minimum power level). Third power level 204 is illustrated in FIG. 2 as a line originating from HBS 201 and culminating in a line-style arrow. At third power level 204, home MS 115 is still within coverage. Home MS 116, however, is no longer within coverage. On the other hand, both foreign MS 111 and MS 112 now experience an acceptably low level of interference from HBS 201.

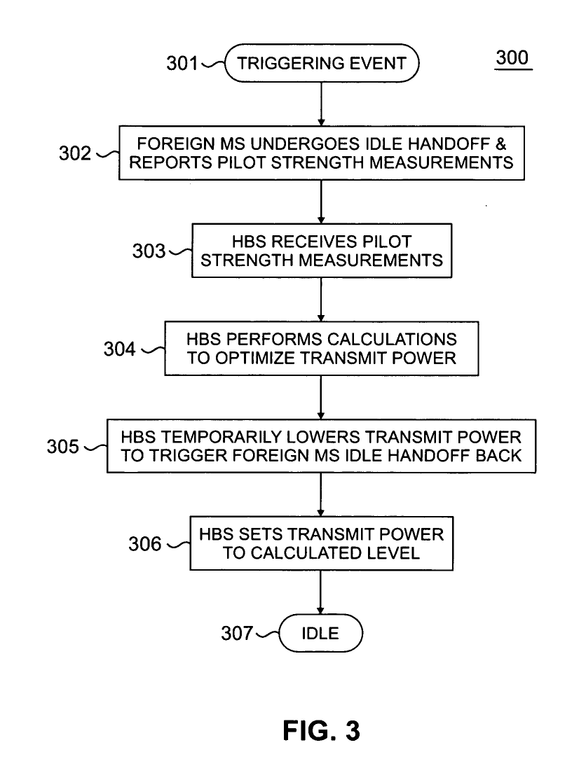

FIG. 3 is an exemplary flow diagram for method 300. Method 300 seeks to optimize a system such as system 200, depicted in FIG. 2. Specifically, method 300 seeks to mitigate interference with foreign mobile stations while maintaining coverage with home mobile stations. Although there are several system optimizing scenarios possible, FIG. 3 illustrates an exemplary method in accordance with the present embodiment.

Before Method 300 begins, all mobiles stations in FIG. 2 are assumed to be in the Idle Mode. HBS 201 may be serving home mobile stations MS 115 and MS 116, but is not serving foreign mobile stations MS 111 and MS 112. In fact, HBS 201 does not even know if mobile stations MS 111 and MS 112 are within its vicinity. For simplicity, this example will ignore MS 116 and MS 112 and consider only home MS 115 and foreign MS 111.

Method 300 begins with a triggering event in step 301. One such triggering event may be when a periodic wake-up of HBS 201 occurs to check and/or adjust its transmit power. A periodic wake-up of HBS 201 begins by HBS 201 temporarily raising its transmit power by a nominal 6 dB. In step 302, a nominal 3 dB hysteresis is overcome in foreign MS 111 and causes it to idle handoff from macro BS 101 to HBS 201. With the proper system configuration, idle handoff will cause MS 111 to send a Registration Message to HBS 201. HBS 201 also sends home MS 115 a Registration Request Message to elicit a Registration Message from MS 115. The Registration Messages from mobile stations MS 111 and MS 115 include pilot strength measurements taken from HBS 201 and macro BS 101. In step 303, HBS 201 receives the Registration Messages containing the pilot strength measurements.

In step 304, HBS 201 uses the measurements received in step 303 to perform calculations to optimize its transmit power (as later described in detail herein). As an example, in step 304, HBS 201 may calculate the transmit power required for HBS 201 to cause its interference to MS 111 to be acceptably low according to one or more of the following options: (a) set the pilot strength at MS 111 from macro BS 101 to an acceptably high value; (b) set the pilot strength at MS 111 from HBS 201 to an acceptably low value; or (c) set the ratio of the pilot strengths at MS 111 from macro BS 101 and HBS 201 to an acceptably high value (using Equation #1 described in detail below). Regardless of whether HBS 201 chooses one of options “a”, “b,” or “c”, or not, HBS 201 may choose (and preferably does) the following as part of step 304: (d) calculates the transmit power that would provide adequate coverage to MS 115 (using Equation #2 described in detail below). The calculated transmit power found in option “a”, “b” or “c” above and the calculated transmit power derived from Equation #2 in “d” may be combined for an optimized transmit power. For example, an optimized transmit power may be an average or a weighted average of the two transmit powers. Alternatively, the optimized transmit power may be the higher of the two transmit powers. In yet another alternative, the optimized transmit power may be the lower of the two transmit powers. In the specific case where the transmit power to achieve “a”, “b”, or “c” (a low enough interference to the foreign MS 111) is lower than the transmit power to achieve “d” (a good enough coverage for home MS 115), a weighted average may be chosen as a compromise between the two conflicting goals.

Equation #1 is also used in step 304 to calculate the transmit power required to cause foreign MS 111 to overcome a nominal 3 dB of hysteresis in the opposite direction, thus triggering idle handoff back to macro BS 101. If the optimized transmit power level is lower, the power is then set to the optimized level in step 306. Otherwise, step 305 is executed. In step 305, HBS 201 temporarily lowers its transmit power to trigger an idle handoff of foreign MS 111 back to macro BS 101. Then, in step 306, HBS 201 sets its transmit power to the optimized level calculated in step 304. Finally, method 300 ends in step 307 and remains in idle until another triggering event in step 301.

The algorithm used to calculate the desired transmit power for option “c” and the transmit power to cause an idle handoff back to the macro BS 201 above is exemplified by Equation #1 below. Equation #1 is shown in both the linear and logarithmic forms.
Pₜₓ₂/Pₜₓ₁=([Ec/Io]_{macro}/[Ec/Io]_{HBS})/R (Linear)
Pₜₓ₃−Pₜₓ₁=([Ex/Io]_{macro}−[Ec/Io]_{HBS})−D (Logarithmic) Equation #1

Specifically, Equation #1 calculates the change in transmit power required to provide a desired linear ratio R or logarithmic difference D (dB) between the respective pilot strengths from a macro base station (such as BS 101) and a home base station (HBS 201), both at a foreign mobile station (MS 111). Pₜₓ₁ represents the current transmit power of HBS 201, while Pₜₓ₂ represents the transmit power of HBS 201 to achieve the desired R or D. [Ec/Io]_{macro} represents the currently measured pilot strength from macro BS 101, while [Ec/Io]_{HBS} represents the currently measured pilot strength from HBS 201.

Using the logarithmic form of Equation #1, suppose, for example, that the current transmit power of HBS 201 (P_{TX1}) is equal to +2 dBm. Suppose further that the current pilot strength from macro BS 101 ([Ec/Io]_{macro}) is −11 dB, while the pilot strength from HBS 201 ( [Ec/Io]_{HBS}) is −5 dB. Now, suppose that the desired difference between the respective pilot strengths of macro BS 101 and HBS 201 (D) is 3 dB, equivalent to a ratio (R) of 2. Using these values in Equation #1 above, the change in transmit power of HBS 201 required to achieve this 3 dB difference is calculated as −9 dB, and the resulting transmit power (Pₜₓ₂) is −7 dBm. In this example, the difference of 3 dB is sufficient to overcome hysteresis and trigger MS 111 to idle handoff back to macro BS 101. Thus, step 305 may be skipped and method 300 continues with step 306. However, if the difference were less than 3 dB, the transmit power would temporarily be set to achieve a difference of at least 3 dB, as calculated above, to cause idle handoff in step 305. In this specific case, the adjustment to the final transmit power would then be made in step 306. Note that the difference D between the pilot strengths from macro BS 101 and HBS 201 at the foreign MS 111 could very well be desired to be less than 3 dB and perhaps even negative (i.e., the pilot strength from HBS 201 would end up slightly higher than that from macro BS 101).

Thus, exemplary systems in accordance with the present disclosure may be optimized by simply securing one set of pilot strength measurements and then calculating a final transmit power level. There is therefore no need to repeatedly set the transmit power level and then secure the respective pilot strength measurements at each level until a final transmit power level is determined.

$$\frac{{P}_{tx 2}}{{P}_{tx 1}} = \frac{{( {[ Ec / Io ]}_{1} )}^{- 1} - O}{{( {[ Ec / Io ]}_{2} )}^{- 1} - O} ( Linear form ) \qquad Equation \#2$$

Equation #2 above calculates the change in transmit power required for HBS 201 to provide adequate coverage to home MS 115 in step 304 “d” above. Pₜₓ₁ represents the current transmit power of HBS 201, while Pₜₓ₂ represents the transmit power to provide adequate coverage. The current pilot strength of a home mobile station, such as MS 115, is designated by [Ec/Io]₁, while the pilot strength to provide adequate coverage for the home mobile station, such as MS 115, is designated by [Ec/Io]₂. O represents the ratio of the total overhead transmit power (i.e., of the Pilot+Sync+Paging channels) to the Pilot channel transmit power for HBS 201.

As an example, suppose that HBS 201 required calculation of a transmit power, Pₜₓ₂, to provide a home mobile station, such as MS 115, with a desired pilot strength, [Ec/o]₂, of −11 dB. Suppose further that when the transmit power, Pₜₓ₁, is equal to +2 dBm, the pilot strength of MS 115, [Ec/Io]₁, is equal to −5 dB. First, the respective pilot strength ratios are converted from logarithmic to linearly scaled values. Thus, the current pilot strength of the home mobile station, [Ec/Io]₁, having a value of −5 dB would equal 0.32 on a linear scale, while the desired pilot strength of the home mobile station, [Ec/o]₂, having a value of −11 db would equal 0.08 on a linear scale. O is calculated using known HBS 201 gain levels for the Pilot, Sync and Paging channels. A typical value of O is 1.89.

The ratio between the desired HBS transmit power and the current HBS transmit power,

$$\frac{{P}_{tx 2}}{{P}_{tx 1}} ,$$

is thus determined by Equation #2 to equal 0.12. Converting to logarithmic values, the desired change in the HBS transmit power, Pₜₓ₂−Pₜₓ₁, equals −9.2 dB. Therefore, in order for the pilot strength of home base station, [Ec/o]₂, to equal −11 dB, the transmit power of HBS 201, Pₜₓ₂, should be set to +2 dBm+(−9.2 dB)=−7.2 dBm. Thus, exemplary systems in accordance with the present disclosure may be optimized by securing one pilot strength measurement and making simple calculations of a final transmit power level. There is therefore no need to repeatedly set the transmit power level and then secure the respective pilot strength measurements at each level until a final transmit power level is determined.

As described above, the calculated transmit power found from Equation #1 above (where Pₜₓ₂=−7 dBm) and the calculated transmit power found from Equation #2 (where Pₜₓ₂=−7.2 dBm) may be averaged together for an optimized transmit power (e.g., −7.1 dBm). Alternatively, the higher of the two transmit powers (−7 dBm) or the lower of the two transmit powers (−7.2 dBm) may be ultimately chosen as the optimized transmit power, depending on whether coverage for the home mobile station or interference mitigation for the foreign mobile station, respectively, is favored.

In step 302, for MS 111 to recognize the pilot signal from the home base station HBS 201, the identification (or PN offset) of HBS 201 must have been broadcast to MS 111 by BS 101 in its Neighbor List message. Similarly, HBS 201 must broadcast the PN offset of BS 101 in its Neighbor List message to its home mobile stations such as MS 115. After MS 111 recognizes the pilot signal from HBS 201 and performs an idle handoff to HBS 201 if the pilot strength from HBS 201 is 3 dB higher than from all other base stations, to get MS 111 to automatically send a Registration Message to HS 201, it must have broadcast a Network Identification (NID) or Registration zone number (REG_ZONE) different from the neighboring macro base stations.

HBS 201 pilot strength, [Ec/Io]_{HBS}, will become high enough to trigger idle handoff by a foreign mobile station MS 111 in a number of scenarios besides the periodic transmit power check described herein above in conjunction with step 301. For example, an idle handoff may be triggered when HBS 201 first powers up with a maximum transmit power. An idle handoff may also be triggered when MS 111 appears at a more disadvantaged location or time than previously encountered (e.g., during busy hour with higher interferences from neighboring macro base stations), causing lower macro BS 101 pilot strength and/or a higher HBS 201 pilot strength.

With regard to the periodic transmit power check in described in conjunction with step 301 herein above, it may be beneficial to temporarily raise the transmit power of HBS 201 late at night when foreign mobile stations are in the neighborhood but are less likely to be used.

There may be multiple foreign mobile stations reporting their respective pilot strengths to HBS 201 at the same time. In this situation, the simplest approach is to calculate Equation #1 for each mobile station and then select the result with the lowest transmit power, to accommodate the mobile station that is suffering the most interference. Similarly, if there are multiple home mobile stations, the simplest approach is to select the one with the lowest current pilot strength to calculate Equation #2, thus resulting with the highest transmit power required. A better but more complex approach is to keep a recent history of the transmit power levels both to mitigate interference to foreign mobiles stations and to provide coverage to home mobile stations, and then select the lowest of the former and the highest of the latter. Alternatively, the lowest 95^{th} percentile of the former and the highest 95^{th} percentile of the latter could be selected. In any case, the average, higher, or lower of these two values is then taken, as described herein above.

Note that other home base stations in the vicinity of HBS 201 are, in essence, macro base stations in that the home mobile stations they serve are foreign mobile stations with respect to HBS 201. Such foreign mobile stations should be treated exactly as foreign mobile stations such as MS 111 that are served by macro base stations such as BS 101. In addition, the PN offsets of neighboring home base stations (as well as macro base stations) should be included in the Neighbor List message broadcast by HBS 201. There must also be a unique NID or REG_ZONE per unique PN offset identifying each home base station, to force a Registration Message to be sent on idle handoff between home base stations.

Although the present disclosure has been described with an exemplary embodiment, various changes and modifications may be suggested to one skilled in the art. It is intended that the present disclosure encompass such changes and modifications as fall within the scope of the appended claims.

1. For use in a wireless communication network, a system for optimizing transmit power, the system comprising:
a home base station (HBS) capable of:
communicating with a first mobile station and a second mobile station within a wireless network; and
setting an optimized HBS transmit power to provide an adequate pilot strength at the first mobile station from the HBS,
wherein the optimized HBS transmit power is determined by a current HBS transmit power, a current pilot strength at the first mobile station, and a ratio between a total overhead transmit power to a pilot channel transmit power.

2. The system according to claim 1, wherein the HBS raises the current HBS transmit power to trigger an idle handoff of the second mobile station to the HBS.

3. The system according to claim 2, wherein the HBS receives pilot strength measurements from the second mobile station.

4. The system according to claim 3, wherein the HBS sets the optimized HBS transmit power to provide an acceptably high pilot strength at the second mobile station from a second base station associated with the second mobile station.

5. The system according to claim 3, wherein the HBS sets the optimized HBS transmit power to provide an acceptably low pilot strength at the second mobile station from the HBS.

6. The system according to claim 3, wherein the HBS sets the optimized HBS transmit power to provide a desired ratio of pilot strengths at the second mobile station.

7. The system according to claim 6, wherein the desired ratio of pilot strengths is the ratio of a pilot strength from the second base station to a pilot strength from the HBS.

8. The system according to claim 7, wherein the optimized HBS transmit power is determined from pilot strengths of (1) the second mobile station from the second base station and (2) the second mobile station from the HBS, and the desired ratio of pilot strengths.

9. For use in a wireless communication network, a method for configuring a home base station (HBS), the method comprising:
setting an optimized transmit power of the HBS,
wherein setting the optimized transmit power provides at least one of:
an acceptably high pilot strength at a second mobile station from a second base station associated with the second mobile station;
an acceptably low pilot strength at the second mobile station from the home base station;
a desired ratio of pilot strengths at the second mobile station; and
an adequate pilot strength at the first mobile station from the HBS, determined by a current HBS transmit power, a current pilot strength at the first mobile station, and a ratio between a total overhead transmit power to a pilot channel transmit power.

10. The method according to claim 9 further comprising:
raising a current transmit power to trigger an idle handoff of the second mobile station to the HBS.

11. The method according to claim 9, wherein the desired ratio of pilot strengths is the ratio of a pilot strength from the second base station to a pilot strength from the HBS.

12. The method according to claim 11, wherein the optimized HBS transmit power is determined from pilot strengths of (1) the second mobile station from the second base station and (2) the second mobile station from the HBS, and the desired ratio of pilot strengths.

13. For use in a wireless communication network, a computer program embodied on a computer readable medium and capable of being executed by a processor, the computer program comprising computer readable program code for:
a home base station (HBS) capable of:
communicating with a first mobile station and a second mobile station within a wireless network; and
setting an optimized HBS transmit power to provide an adequate pilot strength at the first mobile station from the HBS,
wherein the optimized HBS transmit power is determined by a current HBS transmit power, a current pilot strength at the first mobile station, and a ratio between a total overhead transmit power to a pilot channel transmit power.

14. The computer program according to claim 13, wherein the HBS raises a current transmit power to trigger an idle handoff of the second mobile station to the HBS.

15. The computer program according to claim 14, wherein the HBS receives pilot strength measurements from the second mobile station.

16. The computer program according to claim 15, wherein the HBS sets the optimized HBS transmit power to provide an acceptably high pilot strength at the second mobile station from a second base station associated with the second mobile station.

17. The computer program according to claim 15, wherein the HBS sets the optimized HBS transmit power to provide an acceptably low pilot strength at the second mobile station from the HBS.

18. The computer program according to claim 15, wherein the HBS sets the optimized HBS transmit power to provide a desired ratio of pilot strengths at the second mobile station.

19. The computer program according to claim 18, wherein the desired ratio of pilot strengths is the ratio of a pilot strength from the second base station to a pilot strength from the HBS.

20. The computer program according to claim 19, wherein the optimized HBS transmit power is determined from pilot strengths of (1) the second mobile station from the second base station and (2) the second mobile station from the HBS, and the desired ratio of pilot strengths.
